(19) United States
(12) Patent Application Publication
(10) Pub. No.: US 2013/0155096 A1
(43) Pub. Date: Jun. 20, 2013

(54) MONITOR ORIENTATION AWARENESS

(71) Applicant: Christopher J. Legair-Bradley, Pickering, CA (US)

(72) Inventor: Christopher J. Legair-Bradley, Pickering, CA (US)

(21) Appl. No.: 13/326,708

(22) Filed: Dec. 15, 2011

(51) Int. Cl. G09G 5/00

(52) U.S. Cl. 345/619

(57) ABSTRACT

A system and method for processing video data related to configurable monitor orientations. A graphics processing unit (GPU) is connected to one or more monitors. Orientation information associated with a given monitor of the one or more monitors is stored. The orientation information includes at least a three-dimensional set of coordinates indicating a location of the given monitor with respect to a user. The orientation information may also include an indication of a rotation of the given monitor with respect to at least the user and possibly another monitor. In response to determining updated orientation information is available, a graphics driver sends it to the processor when the processor requests it. The processor adjusts graphics commands based on the updated orientation information. The graphics driver directs the GPU to render data associated with an image presented on the given monitor with the adjusted commands based on the updated orientation information.

### FIELD OF THE INVENTION

This invention relates to computing systems, and more particularly, to processing video data related to configurable monitor orientations.

### BACKGROUND

Multiple-display technology enables a single graphics processing unit (GPU) to simultaneously support multiple independent display outputs. In one example, a computing system may independently connect up to six high-resolution displays in various combinations of landscape and portrait rotations, different distances from one another and from the user, and different rotations with respect to a vertical axis. Additionally, two or more of the six monitors in this example may be grouped into a large integrated display surface. This “surround-sight” feature provides an expanded visual workspace. Gaming, entertainment, medical, audio and video editing, business and other applications may take advantage of the expanded visual workspace and increase multitasking opportunities.

When an orientation is unknown for one or more monitors that are used as independent display outputs, a software application may use a default setting describing a placement of the one or more monitors with zero rotation with respect to any one of a triplet of axes. In order to describe a three-dimensional (3D) space, a triplet of axes with each pair perpendicular to one another may be used. Typically, a default setting describes each display as arranged in a flat configuration side by side with one another. If the multiple displays are positioned differently, scenes rendered on the one or more displays may appear visually incorrect.

For example, a three-display configuration may have three displays positioned next to one another, but each of the left and the right displays may be positioned at 45 degrees with respect to the middle display. A software application may utilize three-dimensional (3D) scenes for at least gaming, business, medical, or computer aided design (CAD) purposes. In this example, the left and the right displays may be used for peripheral vision. However, the scenes rendered on the left and the right displays may appear visually incorrect since the scenes are rendered without taking into account the 45-degree orientation.

In such a three-display configuration, a horizontal 3D line on the middle display may reach each edge of the screen of the display. This horizontal line may continue on each of the left and the right displays. On each of these displays, the line may be drawn horizontally, since the 45-degree orientation is not taken into account by rendering software and hardware associated with each of the left and the right displays. From a user's point-of-view, which does take into account the 45-degree orientation, the horizontal line continuing on each of the left and the right displays appears to be descending in a downward direction as if the scenes rendered on these displays are folded away from the user. Additionally, if the displays are moved, a new application or a new configuration may be desired. Further, an advantage for a user includes a monitor directed to a chosen location in a 3D space other than a location shown by other monitors in the configuration. Two examples include a monitor that provides a view behind the user for video games and an aerial view for a CAD application.

In view of the above, efficient methods and systems for efficiently processing video data related to configurable monitor orientations are desired.

### SUMMARY OF EMBODIMENTS

Systems and methods for efficiently processing video data related to configurable monitor orientations are contemplated.

In one embodiment, a computing system includes at least one graphics processing unit (GPU) connected to one or more monitors. Orientation information associated with a given monitor of the one or more monitors is stored. In one embodiment, the orientation information includes at least a two-dimensional set of coordinates indicating a location of the given monitor with respect to a frame of reference (e.g., a user or another monitor). In another embodiment, the orientation information includes a three-dimensional set of coordinates indicating a location of the given monitor with respect to the frame of reference. The orientation information may also include an indication of a rotation of the given monitor with respect to at least the user and possibly another monitor.

The computing system also includes a management application (such as a software application or a graphics driver) and a processor. In one exemplary embodiment the management application comprises the graphics driver. The graphics driver directs the GPU to render data according to graphics commands received from the processor. In response to determining updated orientation information is available for a given monitor of the one or more monitors, the graphics driver receives the updated orientation information from the user or from the given monitor if the monitor has a gyroscope or other hardware for automatic orientation updates. The graphics driver stores the updated orientation information and sends it to the processor when the processor requests the information. The processor adjusts graphics commands based on the updated orientation information and sends the adjusted commands to the graphics driver and to the GPU. The graphics driver directs the GPU to render data associated with an image presented on the given monitor based on the updated orientation information. The image may visually appear correct to the user according to the updated orientation of the given monitor. Alternatively, the image may appear correct from a point-of-view directed by the user, such as a view behind the user or an aerial view.

These and other embodiments will be further appreciated upon reference to the following description and drawings.

### BRIEF DESCRIPTION OF THE DRAWINGS

FIG. 1 is a generalized block diagram of one embodiment of a computing system.

FIG. 2 is a generalized block diagram of one embodiment of a video graphics subsystem.

FIG. 3 is a generalized block diagram of one embodiment of a multi-display configuration.

FIG. 4 is a generalized block diagram of one embodiment of a graphical user interface (GUI) for monitor display setup.

FIG. 5 is a generalized block diagram of one embodiment of a video graphics driver layering model.

FIG. 6 is a generalized flow diagram of one embodiment of a method for collecting, relaying, and using monitor orientation information when presenting 3D scenes.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION OF EMBODIMENTS

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

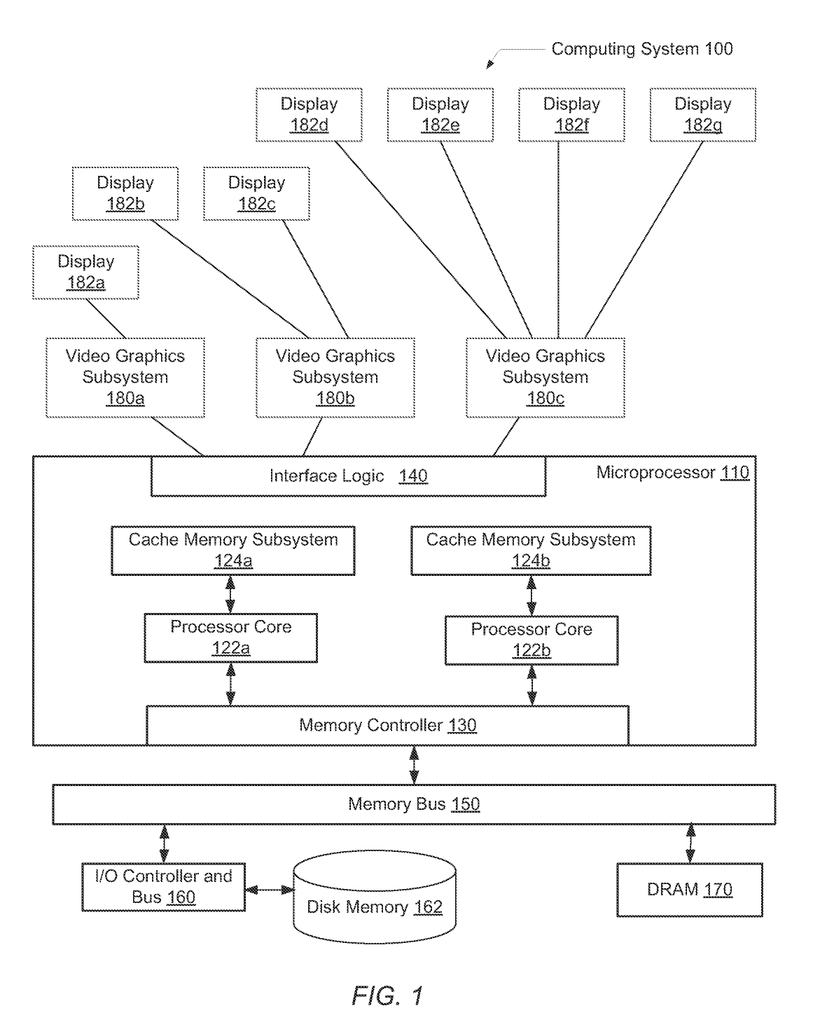

Referring to FIG. 1, a generalized block diagram of one embodiment of a computing system 100 is shown. As shown, microprocessor 110 may be connected to one or more video graphics subsystems 180a-180c. In one embodiment, one or more of the video graphics subsystems 180a-180c is a video graphics card in a slot on a motherboard, which includes the microprocessor 110. In other embodiments, one or more of the of the video graphics subsystems 180a-180c is a separate chip on a system-on-a-chip (SOC), which may be separate from or include the microprocessor 110. Each one of the video graphics subsystems 180a-180c may include one or more processing units such as graphics processing units (GPUs), both a cache memory subsystem and a separate memory subsystem, such as dynamic random access memory (DRAM), for storing video data to be processed by a GPU and read by one or more displays, and one or more interfaces to communicate with the displays and with the microprocessor 110. As will be appreciated by those of ordinary skill, aspects of the present invention could be performed in software running on a general purpose processor such as a CPU. In some embodiments, the microprocessor 110 may be included in a desktop or a server. In other embodiments, the microprocessor 110 may be included in a tablet, a laptop, a smartphone or another type of mobile device.

In one embodiment, a GPU supports one to two display outputs simultaneously and independently. For example, the video graphics subsystem 180a may include a GPU that supports, or is currently configured to support, a single display, such as display 182a. The video graphics subsystem 180b may include a GPU that supports two displays, such as displays 182b-182c. The computing system 100 may support more than two displays by combining multiple GPUs on a single graphics card. Alternatively, the computing system 100 may use two or more graphics cards.

In yet other embodiments, the computing system 100 may utilize a graphics card that supports more than two displays. For example, the video graphics subsystem 180c may include a GPU that supports more than two displays, such as the four displays 182d-182g. Although the video graphics subsystem 180c is shown to support four independent display outputs for the four displays 182d-182g, another number of independent display outputs greater than two may be supported by the video graphics subsystem 180c. In one example, the video graphics subsystem 180c includes a FirePro™ graphics card from Advanced Micro Devices, Inc. When enabled to support more than two displays, this type of graphics card may be connected to displays with native DisplayPort™ connectors, and/or DisplayPort™ compliant active adapters that convert a display's native analog input signals to the graphics card's DisplayPort™ or Mini-DisplayPort™ connector(s).

The DisplayPort connectors utilize data transmission with packets similar to other data communication protocols such as Ethernet, Universal Serial Bus (USB), and PCI Express. The DisplayPort protocol uses small data packets with embedded clocks. In contrast to other digital display interfaces, the DisplayPort protocol does not use a dedicated clock signal for each display output. The data link is fixed at a particular data rate per lane, irrespective of the timing of the attached display device.

In one embodiment, the video graphics subsystem 180c utilizes Eyefinity™ technology from Advanced Micro Devices, Inc., to provide support for multiple independent display outputs. This technology may include both hardware, such as the above-discussed graphics card and connectors and adapters, and software to allow software applications to take advantage of the independent display outputs. Gaming, medical, business, and computer aided design (CAD) industries may take advantage of this technology. The multiple displays 182a-182g driven by multiple independent display outputs may be arranged in several different configurations. For example, the multiple displays may be placed next to one another, on top of one another, spaced apart, and utilize either landscape or portrait rotation setups. However, while utilizing multiple displays to render portions of a same three-dimensional (3D) scene, the software rendering the scene may not be aware of the orientation of the displays.

When an orientation of one or more displays used as independent display outputs is unknown, the software application may use a default setting that describes each display as arranged in a flat configuration side by side one another. A camera for each display may be positioned accordingly. If the multiple displays are positioned differently, the scenes rendered on one or more displays may visually appear incorrect. For example, a three-display configuration may have three displays positioned next to one another, but each of the left and the right displays are positioned at 45 degrees with respect to the middle display. The left and the right displays may be used for peripheral vision. The scenes rendered on the left and the right displays may visually appear incorrect, since the scenes are rendered without taking into account the 45-degree orientation.

Continuing with the three-display configuration example, a horizontal 3D line on the middle display may reach each edge of the screen of the display. This horizontal line may continue on each of the left and the right displays. On each of these displays, the line may be drawn horizontally, since the 45-degree orientation is not taken into account by rendering software and hardware associated with each of the left and the right displays. From a user's point-of-view, which takes into account the 45-degree orientation, the horizontal line continuing on each of the left and the right displays appears to be descending in a downward direction as if the scenes rendered on these displays are folded away from the user. If the software and the hardware on each of the left and the right displays are aware of the 45-degree orientation, the angled left and right displays may show a line that angles up a respective screen.

In one embodiment, the kernel-mode graphics hardware driver is made aware of the orientation of each of the multiple independent displays 182a-182g. In another embodiment, one or more user-mode graphics drivers are made aware of this orientation information. A software application being executed on the microprocessor 110 may query one or more of these drivers through an associated application programmer's interface (API) or the operating system (OS) kernel via a driver escape, or library, interface for the orientation information. When the orientation information is provided to the software application, the application may send command streams and data to be executed by one or more of the video graphics subsystems 180a-180g. The command streams and data may take into account the provided orientation information.

The orientation information may be provided to one or more of the user-mode and/or kernel mode graphics drivers by one of multiple methods. In one embodiment, a graphical user interface (GUI) may allow a user to enter the orientation information. The user may enter angle and distance orientation information. This information may be typed at a command line or menu window in the GUI. Alternatively, one or more test images may be presented on enabled displays. The user may use a peripheral mouse device and/or a keyboard to adjust the images until the images visually appear correct to the user. The resulting orientation information may be saved without the user entering any numerical information. In another embodiment, one or more of the displays 182a-182g contains a gyroscope allowing its orientation information to be automatically obtained. Before further describing embodiments utilizing display orientation information for scene rendering, a further description of the components in the computing system 100 shown in FIG. 1 is provided.

Each of the displays 182a-182g may include modern TV or computer monitors that include a thin film transistor liquid crystal display (TFT-LCD) panel. Additionally, the displays 182a-182g may include monitors for laptops and other mobile devices. Alternatively, one or more of the display devices 102a-102g may include monitors with an organic light-emitting diode (OLED) or other suitable technology.

Each of the LCD displays and the OLED displays may include an active-matrix structure that utilizes a thin-film transistor backplane to switch individual pixels on and off. The active matrix structure includes multiple row lines and multiple column lines. When a row line is selected, each of the column lines is connected to a row of pixels, wherein a single transistor may be used to implement the pixel. A row line may include hundreds to over a thousand pixels. Voltage values related to picture information may be applied to respective lines of the column lines. Afterward, the selected row line may be deselected. Following, a next row line may be selected. The screen of each of the display devices 102a-102g provides the output of the images based on the state of the pixels within each row line.

Each of the displays 182a-182g may have a respective frame buffer in an associated one of the video graphics subsystems 180a-180c. A frame buffer may store data, such as video frames. Access to the data stored in the frame buffer may occur through one or more of the channels of a multi-channel memory architecture. The frame buffers may be stored in dynamic random access memory (DRAM) on a graphics card. For each supported one of the displays 180a-180g, corresponding data may be read for access to a respective frame buffer via a given one of the channels. Each of the channels may include arbitration logic to allow multiple displays of the display devices 102a-102g to access it. A memory clock (MCLK) is used to control a data rate into the frame buffer within the DRAM.

The microprocessor 110 may include one or more processor cores 122a-122b connected to corresponding one or more cache memory subsystems 124a-124b. The microprocessor may also include interface logic 140, and a memory controller 130. Other logic and inter- and intra-block communication is not shown for ease of illustration. In one embodiment, the illustrated functionality of the microprocessor 110 is incorporated upon a single integrated circuit. In another embodiment, the illustrated functionality is incorporated in a chipset on a computer motherboard. In one embodiment, the microprocessor 110 is a stand-alone system within a mobile computer, a smart phone, or a tablet; a desktop; a server; and the like.

Each of the processor cores 122a-122b may include circuitry for executing instructions according to a given instruction set. For example, the x86 instruction set architecture (ISA) may be selected. Alternatively, the Alpha, PowerPC, or any other instruction set architecture may be selected. In one embodiment, each of the processor cores 122a-122b may include a superscalar, multi-threaded microarchitecture used for processing instructions of a given ISA.

Each of the cache memory subsystems 124a-124b may reduce memory latencies for a respective one of the processor cores 122a-122b. In addition, one or more shared cache memory subsystems may be used. The cache memory subsystems 124a-124b may include high-speed cache memories configured to store blocks of data. Each of the cache memory subsystems 124a-124b and 128 may include a cache memory, or cache array, connected to a corresponding cache controller. The cache memory subsystems 124a-124b and 128 may be implemented as a hierarchy of caches. A reduced miss rate achieved by the additional memory provided by the cache memory subsystems 124a-124b and 128 helps hide the latency gap between a given one of the processor cores 122a-122b and the off-chip memory.

If a cache miss occurs, such as a requested block is not found in a respective one of the cache memory subsystems 124a-124b, then a read request may be generated and transmitted to the memory controller 130. The memory controller 130 may translate an address corresponding to the requested block and send a read request to the off-chip DRAM 170 through the memory bus 150. The memory controller 130 may include control circuitry for interfacing to the memory channels and following a corresponding protocol. Additionally, the memory controller 130 may include request queues for queuing memory requests. The off-chip DRAM 170 may be filled with data from the off-chip disk memory 162 through the I/O controller and bus 160 and the memory bus 150.

A corresponding cache fill line with the requested block may be conveyed from the off-chip DRAM 170 to a corresponding one of the cache memory subsystems 124a-124b in order to complete the original read or write request. The off-chip disk memory 162 may provide a non-volatile, random access secondary storage of data. In one embodiment, the off-chip disk memory 162 may include one or more hard disk drives (HDDs). In another embodiment, the off-chip disk memory 162 utilizes a Solid-State Disk (SSD). A Solid-State Disk may also be referred to as a Solid-State Drive. An SSD may emulate a HDD interface, but an SSD utilizes solid-state memory to store persistent data rather than electromechanical devices as found in a HDD.

The off-chip DRAM 170 may be a type of dynamic random-access memory that stores each bit of data in a separate capacitor within an integrated circuit. The capacitor can be either charged or discharged. These two states may be used to represent the two logical values of a bit. The DRAM 170 may utilize a single transistor and a capacitor per bit. Compared to six transistors used in on-chip synchronous RAM (SRAM), the DRAM may reach much higher densities. Unlike HDDs and flash memory, the DRAM 170 may be volatile memory, rather than non-volatile memory. The DRAM 170 may lose its data quickly when power is removed.

The off-chip DRAM 170 may include a multi-channel memory architecture. This type of architecture may increase the transfer speed of data to the memory controller 130 by adding more channels of communication between them. The multi-channel architecture utilizes multiple memory modules and a motherboard and/or a card capable of supporting multiple channels.

In one embodiment, each of the memory modules may each have a same protocol for a respective interface to the memory controller 130. One example of a protocol is a double data rate (DDR) type of protocol. The protocol may determine values used for information transfer, such as a number of data transfers per clock cycle, signal voltage levels, signal timings, signal and clock phases and clock frequencies. Protocol examples include DDR2 SDRAM, DDR3 SDRAM, GDDR4 (Graphics Double Data Rate, version 4) SDRAM, and GDDR5 (Graphics Double Data Rate, version 5) SDRAM. The storage technology and protocols described above for the DRAM 170 may apply for the DRAM within one or more of the video graphics subsystems 180a-180c.

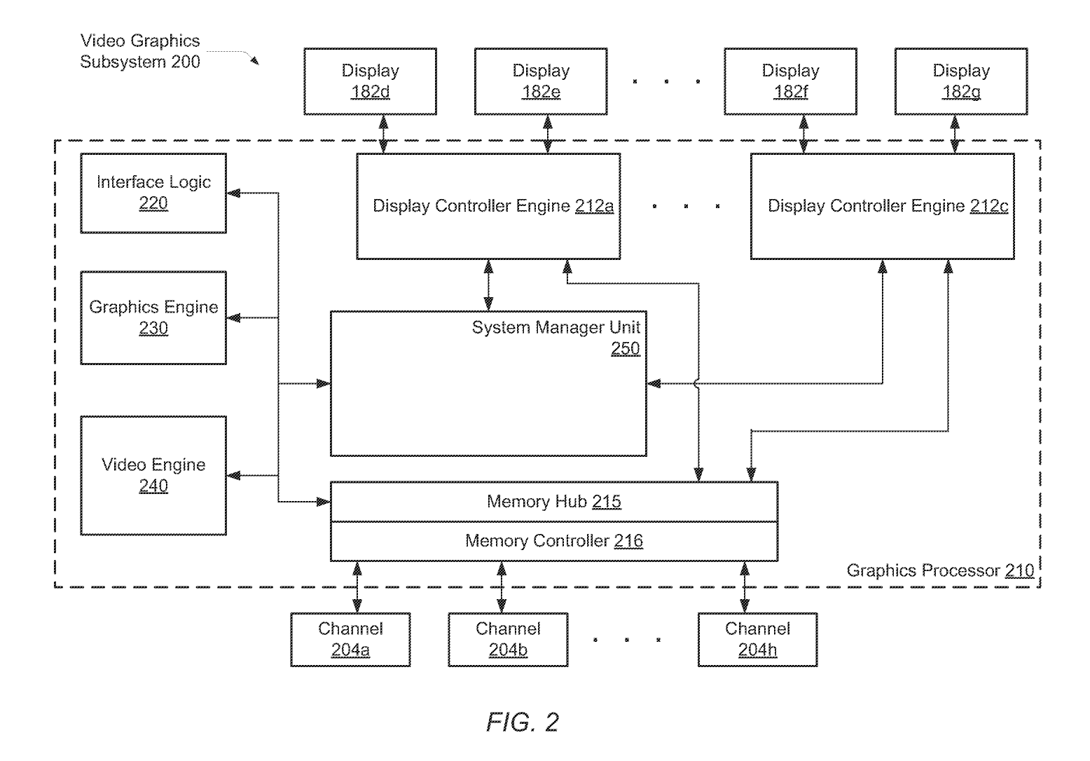

Turning now to FIG. 2, a generalized block diagram of one embodiment of a video graphics subsystem 200 is shown. As shown, multiple displays 182d-182g are connected to a graphics processor 210. As used herein, a graphics processor may also be referred to as a graphics processing unit (GPU). One or more memory channels 204a-204h may also be connected to the graphics processor 210. Each of the memory channels 204a-204h may be a separate interface to a memory, such as a dynamic random access memory (DRAM). As used herein, a memory channel may also be referred to as a channel.

Each of the displays 182d-182g connected to the graphics processor 210 may have a respective frame buffer in the memory, such as the DRAM. A frame buffer may store data, such as video frames, for a corresponding one of the displays 182d-182g. Access to the data stored in the frame buffer may occur through one or more of the channels 204a-204h. For each supported one of the displays 182d-182g, corresponding data may be read for access to a respective frame buffer via a given one of the channels 204a-204h. Each of the channels 204a-204h may include arbitration logic to allow multiple displays of the displays 182d-182g to access it.

The graphics processor 210 includes multiple display controller engines (DCEs) 212a-212c for sending graphics output information to the displays 182d-182g. In addition, the graphics processor 210 includes interface logic 220, a memory hub 215 and a memory controller 216 for supporting access to outside devices and memory. The memory hub 215 may include switching logic to connect a given one of the DCEs 212a-212c to the memory controller 216. The memory controller 216 may include logic for supporting a given protocol used to interface to the memory channels 204a-204h. In various embodiments, the hub 215 and circuitry within the memory controller 216 may be combined or implemented separately as desired. All such embodiments are contemplated. The graphics engine 230 and the video engine 240 may perform data-centric operations for at least graphics rendering and 3D graphics applications.

The system manager unit (SMU) 250 coordinates operations and communications among the multiple components within the graphics processor 210. When frame buffers are updated, the SMU 250 may be instructed to point to new frame buffer data. Accordingly, the addresses stored in the DCEs 212a-212c may be updated to point to the new memory locations corresponding to the new frame buffers.

A video controller and a video connector and/or adapter may be connected between each of the display controller engines (DCEs) 212a-212c and a respective one or more of the displays 182d-182g. Each of the display controller engines (DCEs) 212a-212c may include circuitry for sending rendered graphics output information from the graphics memory, such as the frame buffers. Alternatively, each of the DCEs 212a-212c may send graphics output information from the graphics engine 230 and/or the video engine 240 producing raster-based data results. Frame buffers are typically accessed via a memory mapping to the memory space of the graphics processor 210. The memory mappings may be stored and updated in the DCEs 212a-212c. The information stored in the frame buffers may include at least color values for each pixel on the screen.

A given row line within a screen may have data corresponding to a portion of the large number of pixels within the row line stored in memory connected to memory channel 204a. Similarly, data corresponding to another portion of the large number of pixels within the same given row line may be stored in memory connected to memory channel 204b. In one example, the given row line may have data for the large number of pixels stored in an evenly distributed manner across different memory locations connected to memory channels 204a-204h. The even distribution of the data storage may allow for more efficient techniques to be used for video encoding, raster graphics and so forth.

The multiple channels 204a-204h are included in a multi-channel memory architecture. This type of architecture may increase the transfer speed of data between the memory, such as synchronous dynamic random access memory (SDRAM), and the memory controller 216 by adding more channels of communication between them. The multi-channel architecture utilizes multiple memory modules and a motherboard and/or video graphics card capable of supporting multiple channels. The separate channels 204a-204h allow each memory module access to the memory controller 216 and the memory hub 215, which increases throughput bandwidth. Each of the memory modules may use one of the protocol described earlier.

The interface logic 220 may communicate with other semiconductor chip designs, processing nodes, buses and input/output (I/O) devices. The interface logic 220 may follow an interface protocol that determines a bus standard, error detecting and reporting mechanisms, and signal timings. Generally, the interface logic 220 may include buffers for sending and receiving packets, data and messages.

The interface logic 220 may receive a rendering command stream, state information, and geometry data for floating point operations from a general-purpose processor core or other controller. In some embodiments, rather than providing this information directly, a processor core may provide references to locations in memory at which this information is stored. Accordingly, the graphics processor 210 retrieves the information from the specified locations.

The rendering command stream, state information, and geometry data may be used to define the desired rendered image or images, including geometry, lighting, shading, texture, motion, and/or camera parameters for a scene. In one embodiment, the geometry data includes a number of definitions for objects (e.g., a table, a tree, a person or animal) that may be present in the scene. Groups of primitives (e.g., points, lines, triangles and/or other polygons) may be used to model objects. The primitives may be defined by a reference to their vertices. For each vertex, a position may be specified in an object coordinate system, representing the position of the vertex relative to the object being modeled.

In addition to a position, each vertex may have various other attributes associated with it. Examples of other vertex attributes may include scalar or vector attributes used to determine qualities such as the color, texture, transparency, lighting, shading, and animation of the vertex and its associated geometric primitives. The graphics engine 230 may include one or more texture units for executing pixel shader programs for visual effects. The graphics engine 230 may include additional units for accelerating geometric calculations such as the rotation and translation of vertices into different coordinate systems.

The graphics engine 230 may additionally include multiple parallel data paths. Each of the multiple data paths may include multiple pipeline stages, wherein each stage has multiple arithmetic logic unit (ALU) components and operates on a single instruction for multiple data values in a data stream. The graphics engine 230 may generally execute the same programs, such as vertex shaders or pixel shaders, on large numbers of objects (vertices or pixels). Since each object is processed independently of other objects, but the same sequence of operations is used, a SIMD parallel datapath may provide a considerable performance enhancement. The graphics engine 230 may perform these and other calculations for 3D computer graphics. The video engine 240 may provide a video decoding unit to allow video decoding to be hardware accelerated. In one embodiment, the video engine 240 performs at least frequency transformations, pixel prediction and inloop deblocking, but may send the post-processing steps to the shaders in the graphics engine 230.

Once processing for a pixel or group of pixels is complete, these pixel values may be integrated with pixels of an image under construction. In some embodiments, the new pixel values may be masked or blended with pixels previously written to the rendered image. Afterward, the processed data may be sent to the DRAM for storage via both the memory hub 216 and the channels 204a-204h. At a later time, a given one of the DCEs 212a-212c reads corresponding data stored in the DRAM and sends it to a corresponding one of the displays 182d-182g.

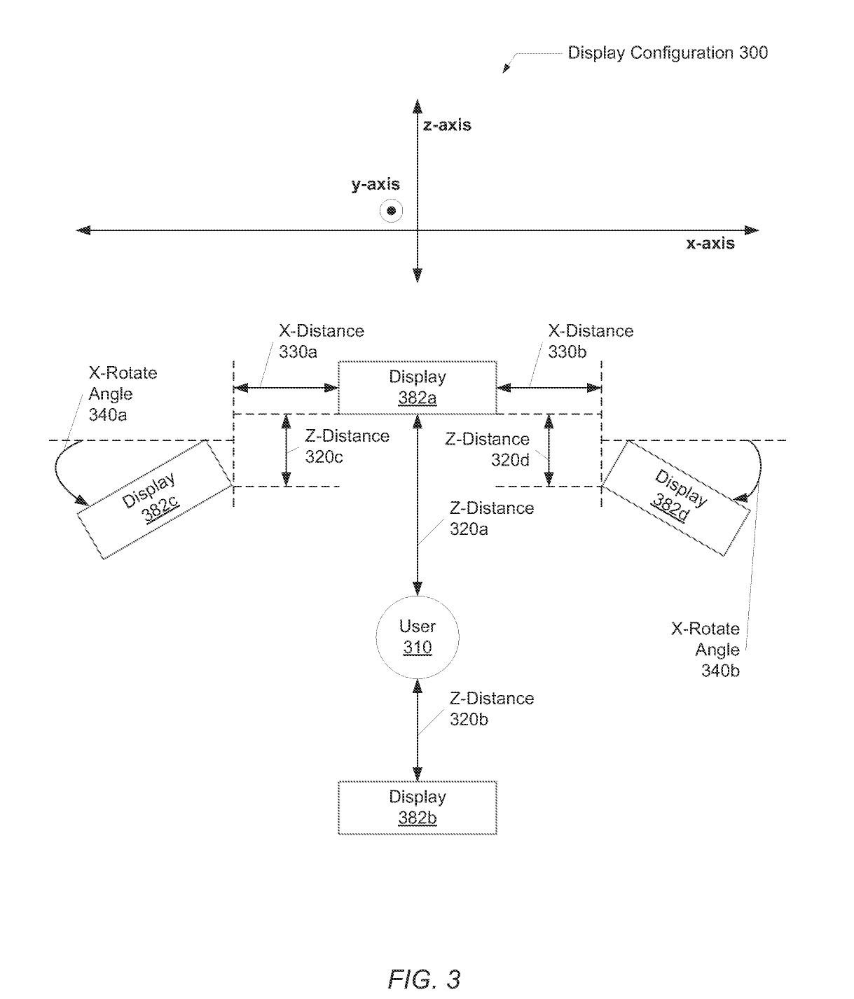

Referring now to FIG. 3, a generalized block diagram illustrating one embodiment of a multi-display configuration 300 is shown. In one embodiment, a Cartesian coordinate system in three dimensions is selected as shown. An ordered triplet of axes with any two of them being perpendicular may be used to describe the positions of multiple displays in three-dimensional space with respect to a user 310. A user 310 may, for example, utilize a multi-display system for gaming, business, medical or other applications. With respect to the user 310, an x-axis may be selected to be a horizontal axis perpendicular to the user 310. A y-axis may be selected to be a vertical axis perpendicular to the x-axis. The z-axis may be selected to be on a same two-dimensional plane as the x-axis with the z-axis traversing through the user 310. Of course the axes may be otherwise chosen.

In the embodiment shown, the user 310 is currently using four monitors, displays 382a-382d, in a multi-display configuration. A first monitor, display 382a, may be positioned straight ahead of the user 310 in a flat orientation. The flat orientation may correspond to a zero rotation about the y-axis. Looking from above, the display 382a is rotated zero degrees from the x-axis frame of reference. The display 382a may be located at a distance indicated by the measurement Z-distance 320a. For example, the display 382a may be located 4 feet, or 48 inches, in front of the user 310.

In a similar manner as described above for the display 382a, a second monitor, display 382b, may be positioned behind the user 310 in a flat orientation. The flat orientation behind the user when looking from above may correspond to the display 382b is rotated 180 degrees from the x-axis frame of reference. The display 382b may be located at a distance indicated by the measurement Z-distance 320b. For example, the display 382b may be located 3 feet, or 36 inches, behind the user 310.

In one embodiment, a third monitor, display 382c, is located to the left of the first monitor, display 382a, with respect to the user 310. In one embodiment, the display 382c may be located immediately next to the display 382a. In other embodiments, the display 382c may be located a nonzero distance from the display 382a. This nonzero distance is indicated by the measurement X-distance 330a.

Additionally, in one embodiment, the display 382c may be positioned in a flat orientation. The flat orientation may correspond to the display 382c is rotated zero degrees from the x-axis frame of reference. In other embodiments, as shown in FIG. 3, the display 382c may not be positioned in a flat orientation. Rather, looking from above, the display 382c may be rotated a nonzero number of degrees from the x-axis frame of reference as shown by the measurement X-rotate Angle 340a. Further, using the display 382a as a frame of reference, the screen of the display 382c may be located a distance from the screen of the display 382a as indicated by the measurement Z-distance 320c.

A fourth monitor, the display 382d, may be located to the right of the first monitor, display 382a, with respect to the user 310. The display 382d may be positioned in a similar manner as described above for the display 382c. The measurements X-rotate Angle 340b and the Z-distance 320d may be used for the display 382d. Although only four monitors are show in the illustrated embodiment, a different number of multiple monitors may be used. Other frames of reference other than the user 310 and the first monitor, the display 382a, may be selected for the distance and rotation measurements used to describe the orientations of the multiple monitors. In various embodiments, the locations and facings of the monitors may be described by 3 coordinates denoting a monitor's physical location (e.g., the center of the monitor), and a rotation about one or more of the axes to denote the direction the monitor is facing. For example, display 382d may be described as being rotated about the x axis by approximately 45 degrees. Display 382c could be described as being rotated about the x axis by −45 degrees. A rotation about another axis may indicate the monitor is facing up or down, while rotation about a third axis may indicate the monitor is rotated. In other embodiments, two points in 3 dimensional space could be used to indicate the location of the monitor and its facing. The first point describing a point of origin and the second being used to describe a vector in space which indicates the monitor's facing. Numerous such embodiments are possible and are contemplated.

Although not shown, each one of the four monitors, displays 382a-382d, may be positioned with a nonzero distance along the y-axis from the user 310. For example, one or more of the displays 382a-382d may be elevated from a chosen line-of-sight. If displays were positioned on top of one another, the top displays would have a higher measured value in the y-direction than an associated display below it. The displays may be mounted on a wall or elevated on stands.

In other embodiments, one or more of the displays 382a-382d may be tilted, or otherwise be positioned with a nonzero rotation angle with respect to the vertical y-axis. Other positions described by nonzero distances and rotations are possible and contemplated. The distance and rotation measurements used to describe the position of the displays 382a-382d in 3D space may be sent to software applications. This information may be presented as coordinates, distances, vectors, degrees of rotation with respect to a given axis, and so forth. In one embodiment, a single frame of reference may be used for each of the orientation measurements. In other embodiments, multiple frames of references may be used, wherein a selected frame of reference is based on which measurement is being described. The software applications executed by general-purpose microprocessors and video graphics subsystems may change the processing of video data and the resulting presentation of video 3D scenes to the user 310 via the multiple monitors based on the received 3D orientation information.

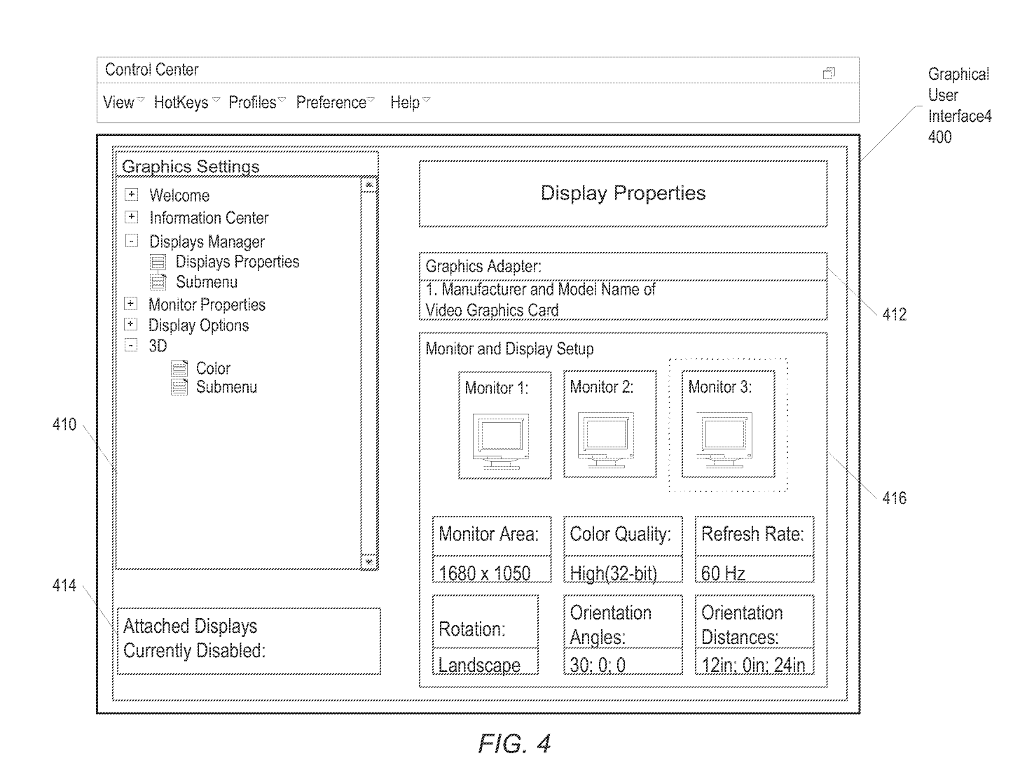

Referring now to FIG. 4, a generalized block diagram illustrating one embodiment of a graphical user interface (GUI) 400 for monitor display setup is shown. The GUI 400 may be presented by a software application installed on a user's desktop, server, laptop, and the like. In one embodiment, the software application is separate from an application used for gaming, business, medical or other purposes. In another embodiment, the code for the GUI may be embedded in the application used for other purposes. In one embodiment, the GUI 400 is presented by the utility software package Catalyst™ Control Center (CCC) from AMD, Inc. The GUI 400 may be used to setup display configurations and provide monitor display orientation information.

The GUI 400 may include a navigation bar, drop-down menus, and fields for entering monitor configuration information. Within the GUI 400 is shown a “Graphics Settings” pane 410, which includes menus and submenus and folders under particular menus. For example, a “Displays Manager” pull-down menu may include at least a “Displays Properties” submenu allowing the user to enter parameters to configure one or more monitors. A “3D” pull-down menu may include at least a “Color” submenu allowing the user to enter parameters to configure an image's appearance on a given monitor. A given menu and/or submenu may be selected as indicated by a highlighted background, a visible outline, and the like. A “Displays Properties” pane 412 may include a field to allow the user to identify a given video graphics card used in a video graphics subsystem. In addition, the user may identify in field 414 attached displays that are currently disabled.

For enabled displays, the pane 416 may allow the user to select a given display of one or more displays and select or enter information regarding the given display. For example, the characteristics associated with the given display may include at least a desktop area, a color quality, a refresh rate, and a rotation of the displayed image. Additionally, the user may enter orientation information for the selected display. A particular field may correspond to orientation rotation angles. These angles may be measured with respect to x-, y-, and z-axes. In one embodiment, these axes have the directions shown in FIG. 3.

In one embodiment, the user may enter display orientation angles by typing within the particular field. In a similar manner, the user may enter orientation distances for the selected display. The frames of reference for the distances may be preset and defined as the frames of reference shown in FIG. 3. Other frames of reference are possible and contemplated. In another embodiment, a pull-down menu may provide options for the angles and distances.

In yet another embodiment, the software application executing the GUI 400 may present a test image on one or more of the enabled displays. The user may use a peripheral mouse device and/or a keyboard to adjust the image shown on the selected display until the image visually appears correct to the user. Onscreen controls may be used as the user slowly navigates through a 3D test scene. The resulting numerical values for the orientation information may be saved by the software application without the user entering numerical values. In one embodiment, the test images may use default settings for common orientations to allow for quick configuration.

In other embodiments, the pane 416 may allow a user to enter a screen size for a given display. For example, a 103 inch television (TV) may be used as the selected display. A second TV may be used as a second display and this second TV may have a 24 inch size. The 24 inch TV may be placed to the right of the 103 inch TV. The image on the 103 inch TV is relatively large, especially compared to an image on the 24 inch TV. With no adjustments, a continuous 3D scene shown across the two TVs would not have a correct visual appearance. However, entering the orientation information and the size information for each of the two TVs may be used to adjust for the size difference. For example, a camera view of the 24 inch TV may be positioned closer to the display image, which enlarges the view shown on the 24 inch TV. This zooming in operation may allow the continuous 3D scene to be shown across the two TVs with a correct visual appearance.

In one embodiment, one or more of the displays may be equipped with a gyroscope allowing its orientation information to be automatically obtained by the software application. When the software application presenting the GUI 400 has obtained the display properties information including the orientation information, this information may stored in a given memory location. This given memory location may be made available to a video graphics driver associated with the identified video graphics card. Software applications for gaming, business, medical, CAD design, and other uses may query the display properties information including the orientation information from the video graphics driver. With the relative camera position information and a directional vector for each of the available and enabled displays, the executing software application may apply this information to its camera orientation code. Accordingly, an optimal camera view for each display may be used.

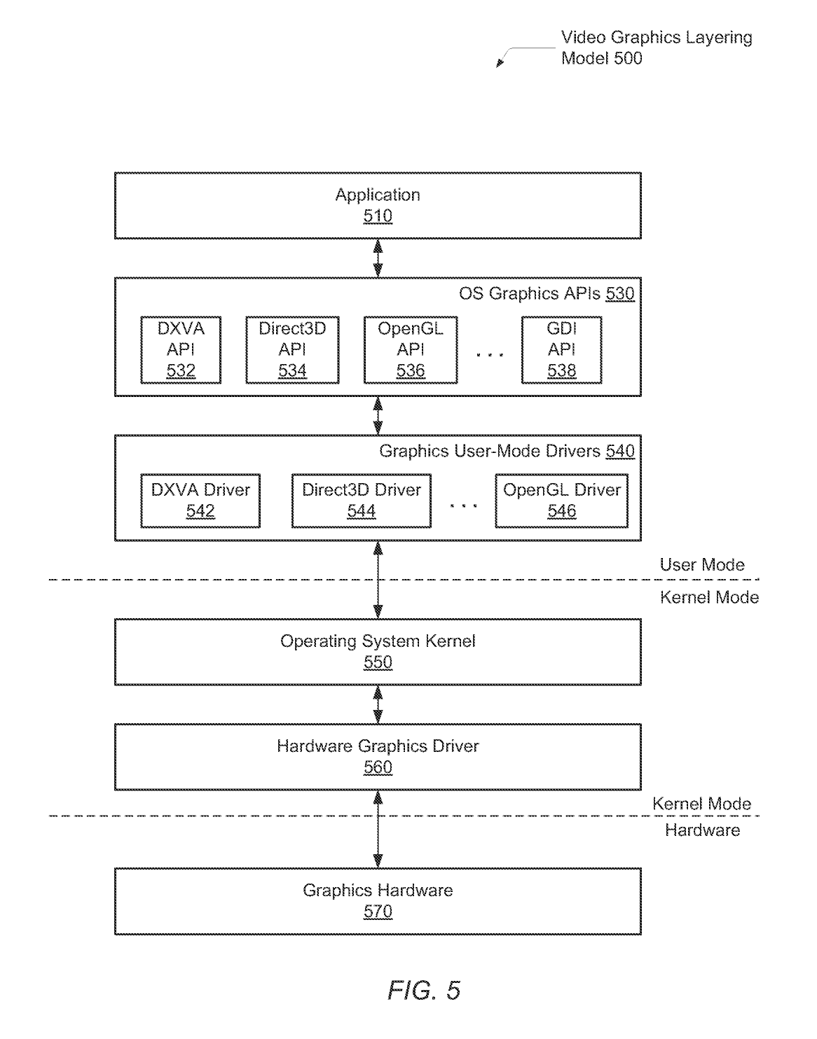

Turning now to FIG. 5, a generalized block diagram illustrating one embodiment of a video graphics driver layering model 500 is shown. As shown, the video graphics driver layering model 500 includes user-mode components and kernel-mode components. In one embodiment, graphics software drivers corresponding to the graphics hardware 570 may include both user-mode components and kernel-mode components. Such a configuration may separate much of the activities of the graphics driver 560 from the operating system and other applications. In addition, some functionalities of the hardware graphics driver 560 may be distributed across drives in the graphics user-mode drivers 540.

In one embodiment, the graphics user-mode drivers 540 are isolated from the OS kernel 550, the kernel-mode graphics driver 560, and the graphics hardware 570. The OS may load a separate copy of the user-mode drivers 540 for each application 510. A graphics hardware vendor may supply the user-mode graphics drivers 540 and the hardware graphics driver 560. The user-mode graphics drivers 540 may each be a dynamic-link library (DLL) that is loaded by corresponding APIs in the OS graphics APIs 530. Alternatively, runtime code may be used to install the user-mode graphics drivers 540.

In one embodiment, one or more of the graphics APIs and the user-mode graphics drivers 540 may be built with a software development kit (SDK) associated with a corresponding operating system. Therefore, the user-mode graphics drivers 540 may be extensions to SDKs supported by the operating system. In one example, the user-mode graphics drivers 540 may be extensions to the Direct3D and OpenGL SDKs. Accordingly, the orientation information of one or more displays may be available through a standard interface. In another example, a driver escape code or sequence supported by the graphics APIs 530 may be used to indicate to the driver that a given portion of a statement is to be handled differently. Escape calls may be included in a user-defined SDK. Applications may include this type of SDK in a library or in a dynamic link library (DLL) form When a corresponding one of the user-mode graphics drivers 540 processes the escaped portion of a string, the driver may translate the portion of the string in order for one or more of the application 510 and the hardware graphics driver 560 to correctly process received information.

The hardware graphics driver 560 communicates with each of the OS kernel 550 and the graphics hardware 570. The OS kernel 550 may include at least a video memory manager and a GPU scheduler. The graphics APIs 530 includes functions that may be called by the graphics drivers 540 to connect to and configure displays.

In an event that the application 510 or one of the user-mode drivers 540 performs an illegal action and causes an error, the application 510 may close while leaving the OS unaffected. Therefore, the user may continue working. In addition, with some of the functionality removed from the kernel-mode graphics driver 560 and placed in one or more of the user-mode drivers 540, there is a smaller probability an error within the graphics driver 560 affects the OS kernel 550.

A software application 510 may be executing code for a gaming, business, medical, CAD design, or other end-user application. The application 510 may send queries to and receive information from the hardware graphics driver 560 via the OS application programmer's interfaces (APIs) 530, the user-mode driver components 540, and the OS kernel 550. In one embodiment, the application 510 may represent a management application configured to obtain monitor orientation information. Application 510 may query the hardware graphics driver 560 to obtain monitor orientation information for each display of one or more available and enabled displays. Based on the orientation information, the application 510 may send corresponding command streams with associated data to be processed by the graphics hardware 570. In alternative embodiments, a driver such as driver 560 may itself represent such a management application, or a combination of application 510 and driver 560 may be referred to as a management application.

One or more APIs within the OS APIs 530 may be used for one or more of the user-mode drivers 540. An OS kernel 550 may receive queries from the OS graphics APIs 530 and the graphics user-mode drivers 540. The OS kernel 550 may pass on queries and other packets and/or messages to the hardware graphics driver 560 according to given protocols. The software application 510 may also send command streams and data while executing code. The command streams may be executed by a GPU within the graphics hardware 570 using the received data.

In the model 500, each user-mode and kernel-mode driver may be responsible for processing a part of a request from the application 510. If a given driver cannot complete the request, information for a driver in a lower layer may be set up and the request is passed along to that driver. The model 500 may allow each driver to specialize in a particular type of function and decouples it from having to know about other drivers. Drivers at a higher layer in the model 500 may add modifications and enhancements to the processing of graphics requests from the application 510 without re-writing underlying drivers.

In one embodiment, the user-mode graphics drivers 540 include a driver 542 that allows video decoding to be hardware accelerated. Certain CPU-intensive operations such as motion compensation and deinterlacing may be offloaded to a GPU. In one embodiment, this driver 542 is a DirectX Video Acceleration (DXVA) driver. In this embodiment, the DXVA driver 542 may follow an API specification from Microsoft Corp. This specification may include the DXVA API 532 within the user-mode graphics APIs 530. In other embodiments, a different driver and API may be used with a same OS kernel 550. In yet other embodiments, a different driver and API may be used with a different OS kernel 550. In one embodiment, Microsoft Vista® may be used as the OS. In other embodiments, Linux® and other types of OSes and corresponding drivers and APIs may be used.

In one embodiment, the user-mode graphics drivers 540 include a driver 544 that performs rendering of three-dimensional (3D) graphics in applications. The driver 544 may identify operations to be performed on the graphics hardware 570, such as at least anti-aliasing, alpha blending, atmospheric effects, and perspective-correct texture mapping. The driver 544 may use hardware acceleration if it is available on the graphics hardware 570. In one embodiment, this driver 544 is a Direct3D graphics driver. In this embodiment, the Direct3D driver 524 may follow an API specification from Microsoft Corp. This specification may include the Direct3D API 534 within the user-mode graphics APIs 530.

In one embodiment, the graphics user-mode drivers 540 include the OpenGL driver 546. In this embodiment, the OpenGL driver 546 may follow an API specification from Microsoft Corp. This specification may include the OpenGL API 536 within the user-mode graphics APIs 530. The OpenGL API 536 is a standard API specification defining a cross-language, cross-platform API for writing applications that produce 2D and 3D computer graphics. The Direct3D API 534 and the OpenGL API 536 are competing APIs, which can be used by the application 510 to render 2D and 3D computer graphics. The APIs 534 and 536 may take advantage of hardware acceleration when available. Modern GPUs may implement a particular version of one or both of the APIs 534 and 536. The Direct3D API 534 generally targets the Microsoft Windows platform. The OpenGL API 536 generally is available for multiple platforms, since the API 536 utilizes an open source license.

In one embodiment, the OS APIs 530 includes the GDI API 538. In this embodiment, the GDI API 538 may follow an API specification from Microsoft Corp. The GDI API 538 represents graphical objects and transmits them to output devices such as monitors and printers. The GDI API 538 may be used to perform tasks such as drawing lines and curves, rendering fonts and handling palettes.

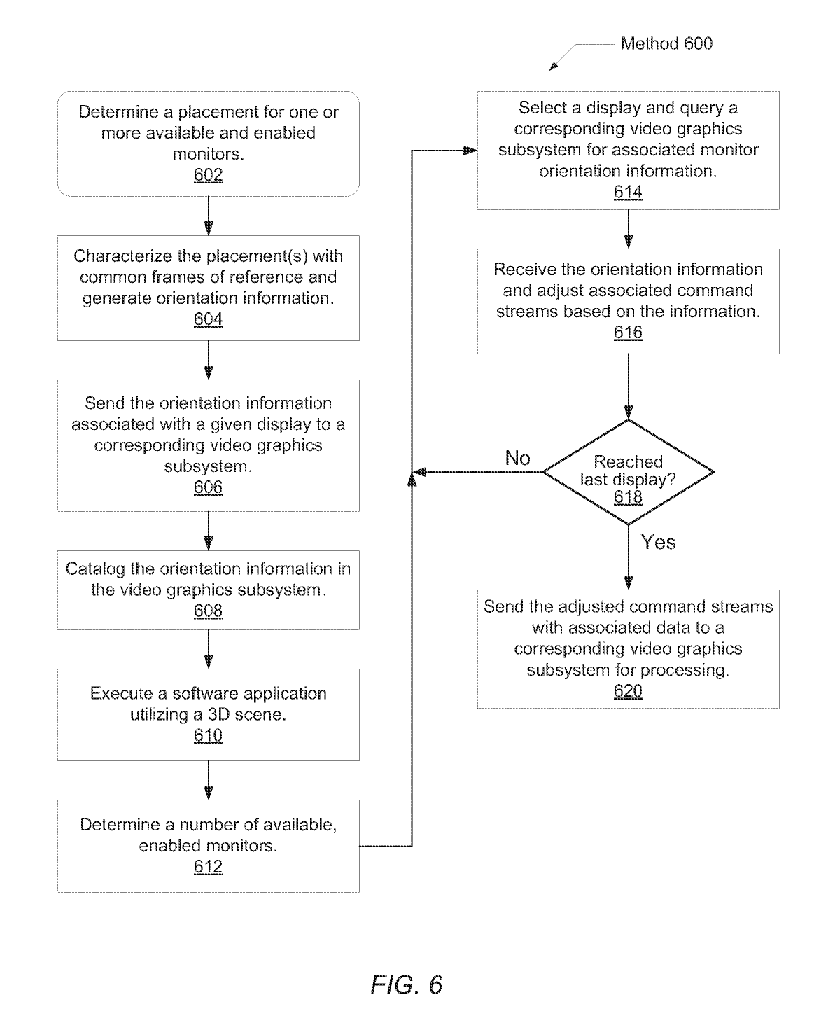

Referring now to FIG. 6, one embodiment of a method 600 for collecting, relaying, and using monitor orientation information when presenting 3D scenes is shown. The components embodied in the computer system described above may generally operate in accordance with method 600. For purposes of discussion, the steps in this embodiment are shown in sequential order. However, some steps may occur in a different order than shown, some steps may be performed concurrently, some steps may be combined with other steps, and some steps may be absent in another embodiment.

In block 602, a placement for one or more available and enabled monitors is determined. A user or an administrator may position the one or more monitors for displaying 3D scenes. Any configuration may be used including at least stacking, setting side by side, rotating, placing a nonzero distance between any two displays, and so forth. It is noted the placement of the monitors may change, or be updated. In response, the steps described below for method 600 may be repeated. In one embodiment, a user or an administrator may initiate the execution of the steps described in method 600. In another embodiment, a signal from a gyroscope indicating an orientation update has occurred may initiate the execution of the steps in method 600.

In block 604, the placement of the one or more displays may be characterized by distances along each one of a triplet of axes used to describe a 3D space and rotated angles with respect to each one of the axes. A user or administrator may record this information. Alternatively, a gyroscope associated with a given display may determine and record orientation information.

In block 606, the orientation information associated with a given display may be sent to a corresponding video graphics subsystem. In one embodiment, a user or an administrator enters the information in a GUI associated with the video graphics subsystem. In another embodiment, a gyroscope sends the information via a wire or via a wireless connection to the video graphics subsystem. In yet other embodiments, the user may enter placement information associated with the monitor in a GUI and a gyroscope may provide orientation information of the screen on the monitor such as any tilting. In one example, the user may manually enter information into the GUI describing the monitor is 20 inches in front of the user and 20 inches to the right. The gyroscope may send information indicating the screen of the monitor is facing a direction 45 degrees from an x-axis used as a frame of reference. The combined data may be used to determine orientation information relative to the user. In block 608, the orientation information is stored in the video graphics subsystem. The orientation information may be stored in a given memory location in memory within the video graphics subsystem. Metadata may be stored with the orientation information such as a timestamp or a version number. The metadata may be used to distinguish orientation information for multiple stored configurations.

In block 610, a software application utilizing a 3D scene may be selected and executed. In block 612, the application may query for a number of available, enabled monitors. The operating system may provide this information to the application. In block 614, the application may select a given display of the one or more available and enabled displays. The applications may query a corresponding video graphics subsystem for associated monitor orientation information. One or more user-mode graphics drivers may be accessed to relay the query to a kernel-mode hardware graphics driver.

In block 616, the orientation information may be sent to the application through a same path as the query. In response to receiving the orientation information, the application may adjust associated command streams based on the information. If the last display has not been processed with updated orientation information (conditional block 618), then the control flow of method 600 returns to block 614. Otherwise, in block 620, the application sends the adjusted command streams with associated data to a corresponding video graphics subsystem for processing. The data may be rendered by the graphics hardware in a manner to present images associated with 3D scenes that visually appear correct to the user.

It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Additionally, program instructions may comprise behavioral-level description or register-transfer level (RTL) descriptions of the hardware functionality in a high level programming language such as C, or a design language (HDL) such as Verilog, VHDL, or database format such as GDS II stream format (GDSII). In some cases the description may be read by a synthesis tool, which may synthesize the description to produce a netlist comprising a list of gates from a synthesis library. The netlist comprises a set of gates, which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. Alternatively, the instructions on the computer accessible storage medium may be the netlist (with or without the synthesis library) or the data set, as desired. Additionally, the instructions may be utilized for purposes of emulation by a hardware based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computing system comprising:
a first processor configured to be coupled to one or more monitors; and
a management application configured to access orientation information associated with a given monitor of the one or more monitors, wherein the orientation information indicates a location of the given monitor with respect to a user in three dimensional space;
wherein the processor is configured to render data associated with an image presented on the given monitor based on the orientation information.

2. The computing system as recited in claim 1, wherein the first processor comprises a graphics processing unit (GPU) and the management application comprises a graphics driver.

3. The computing system as recited in claim 2, wherein the computing system comprises a plurality of monitors.

4. The computing system as recited in claim 1, wherein said orientation information comprises at least a three-dimensional set of coordinates indicating a location of the given monitor.

5. The computing system as recited in claim 4, wherein said orientation information further comprises information that indicates a direction the given monitor is facing.

6. The computing system as recited in claim 5, wherein the direction the given monitor is facing is described by data including at least one of an angle of rotation of the given monitor, or a directional vector associated with the given monitor.

7. The computing system as recited in claim 1, wherein the first processor is configured to render said image differently in dependence on a location of the given monitor with respect to the user.

8. The computing system as recited in claim 1, wherein the computing system further comprises a second processor configured to execute a software application comprising graphics commands to describe the image on the given monitor, wherein in response to determining an update condition is satisfied, the second processor is configured to send a request to the management application for the updated orientation information associated with the given monitor.

9. The computing system as recited in claim 8, wherein the update condition comprises at least one of the following: a startup of the software application, an indication from the user the orientation information is updated, and an indication from a gyroscope the orientation information is updated.

10. The computing system as recited in claim 9, wherein the indication from the user comprises invoking a graphical user interface (GUI) associated with the management application and providing the updated orientation information in one or more fields within the GUI.

11. The computing system as recited in claim 9, wherein the indication from the user comprises invoking a graphical user interface (GUI) associated with the management application and adjusting with peripheral devices coupled to the second processor a test image provided by the GUI, wherein the test image is presented on the given monitor.

12. A method comprising:
accessing orientation information associated with a given monitor of one or more monitors, wherein the orientation information indicates a location of the given monitor with respect to a user in three dimensional space; and
rendering data associated with an image presented on the given monitor based on the orientation information

13. The method as recited in claim 10, wherein said orientation information comprises at least a three-dimensional set of coordinates indicating a location of the given monitor.

14. The method as recited in claim 11, wherein said orientation information further comprises information that indicates a direction the given monitor is facing.

15. The method as recited in claim 12, further comprising providing data including at least one of an angle of rotation of the given monitor, or a directional vector associated with the given monitor, to describe said facing.

16. The method as recited in claim 10, further comprising rendering said image differently in dependence on a location of the given monitor with respect to the user.

17. The method as recited in claim 12, further comprising detecting updated orientation information is available responsive to at least one of the following: a startup of a software application, an indication from the user the orientation information is updated, and an indication from a gyroscope the orientation information is updated.

18. A non-transitory computer-readable storage medium comprising program instructions that are executable to:
access orientation information associated with a given monitor of one or more monitors, wherein the orientation information indicates a location of the given monitor with respect to a user in three dimensional space; and
render data associated with an image presented on the given monitor based on the orientation information

19. The storage medium as recited in claim 18, wherein said orientation information comprises at least a three-dimensional set of coordinates indicating a location of the given monitor.

20. The storage medium as recited in claim 19, wherein said orientation information further comprises information that indicates a direction the given monitor is facing.
